(19) United States
(12) Patent Application Publication
(10) Pub. No.: US 2010/0327469 A1
(43) Pub. Date: Dec. 30, 2010

(54) Method of Manufacturing Condenser Component of Concentration Photovoltaic Module

(75) Inventors: Hung-Zen Kuo, Longtan Shiang (TW); Yam-Mou Shyu, Longtan Shiang (TW); Hwa-Yuh Shin, Longtan Shiang (TW)

Correspondence Address: LEE & HAYES, PLLC, 601 W. RIVERSIDE AVENUE, SUITE 1400, SPOKANE, WA, 99201, US

(73) Assignee: ATOMIC ENERGY COUNCIL-INSTITUTE OF NUCLEAR ENERGY RESEARCH, Taoyuan (TW)

(21) Appl. No.: 12/687,794

(22) Filed: Jan. 14, 2010

(30) Foreign Application Priority Data
Jun. 25, 2009 (TW) 098121382

(51) Int. Cl. B29D 11/00

(52) U.S. Cl. 264/1.1

(57) ABSTRACT

A condenser lens is fabricated. The condenser lens has a lens structure bound with a hard glass substrate. The present disclosure can resist sudden stroke and has good weatherability even when it is used outdoors for long.

### CROSS REFERENCE TO RELATED PATENT APPLICATION

This application claims priority from Taiwan Patent Application No. 098121382 filed in the Taiwan Patent Office on Jun. 25, 2009, entitled “Method of Manufacturing Condenser Component of Concentration Photovoltaic Module”, which is incorporated in its entirety by reference.

### FIELD OF THE DISCLOSURE

The present disclosure relates to manufacturing a condenser component; more particularly, the present disclosure relates to manufacturing a condenser component of concentration photovoltaic module, which has good hardness to effectively resist sudden stroke and has good weatherability to be used outdoors for long.

### DESCRIPTION OF RELATED ART

In general, a condenser lens is fabricated integrally through hot-pressing or injection molding, where a Fresnel structure is formed on a plastic material. The condenser lens having the Fresnel structure is corresponding to a surface of a solar cell to condense a light source on the solar cell. Thus, the solar cell obtains an output power by the coordination of the condenser lens having the Fresnel structure.

However, the condenser lens having the Fresnel structure is made of a plastic material, which has weak weatherability. When the condenser lens is used outdoors for long, it may be deformed owing to sun-burn heat at day and coldness at night. In addition, the condenser lens made through hot-pressing or injection molding does not have good hardness. When the condenser lens is hit by a sudden stroke, it may be broken. Hence, the prior art does not fulfill all users' requests on actual use.

### SUMMARY OF THE DISCLOSURE

The main purpose of the present disclosure is to manufacture a condenser component of concentration photovoltaic module, which has good hardness to effectively resist sudden stroke and has good weatherability to be used outdoors for long.

To achieve the above purpose, the present disclosure is a method of manufacturing a condenser component of concentration photovoltaic module, comprising steps of: (a) providing a light transmission substrate made of strengthened ultra-white glass; (b) pasting a molding material on a mold to form a molding material layer, where the molding material is processed through de-voiding in a vacuum chamber and the mold has a lens forming area; (c) laying the light transmission substrate on the molding material layer over the mold to form the molding material layer by pressing; and (d) after forming the molding material layer, separating the mold from the molding material layer to form a lens structure on a surface of the molding material layer for obtaining the condenser component of the light transmission substrate coordinated with the molding material layer. Accordingly, a novel method of manufacturing a condenser component of concentration photovoltaic module is obtained.

### BRIEF DESCRIPTION OF THE DRAWINGS

The present disclosure will be better understood from the following detailed description of the preferred embodiment according to the present disclosure, taken in conjunction with the accompanying drawings, in which

FIG. 1 to FIG. 5 are the perspective views showing the steps of the preferred embodiment according to the present disclosure; and

FIG. 6 is the view showing the state of use of the condenser component.

### DESCRIPTION OF THE PREFERRED EMBODIMENT

The following description of the preferred embodiment is provided to understand the features and the structures of the present disclosure.

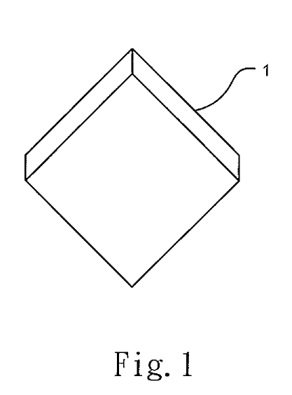

Please refer to FIG. 1 to FIG. 4, which are perspective views showing steps of a preferred embodiment according to the present disclosure. As shown in the figures, the present disclosure is a method of manufacturing a condenser component of concentration photovoltaic module, comprising the following steps:

(a) In FIG. 1, a light transmission substrate 1 made of a hard glass material is provided, where the hard glass material is strengthened ultra-white glass.

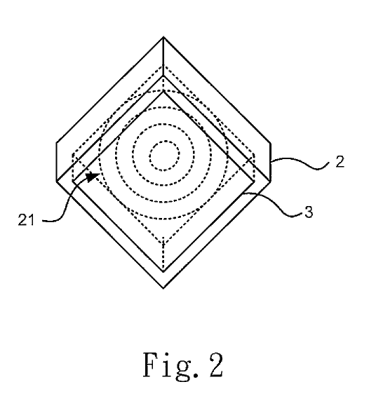

(b) In FIG. 2, a molding material is pasted on a mold 2 to form a molding material layer 3, where the molding material is polymer plastic or silicone; the molding material is processed through de-voiding in a vacuum chamber; and the mold 2 has a lens forming area 21.

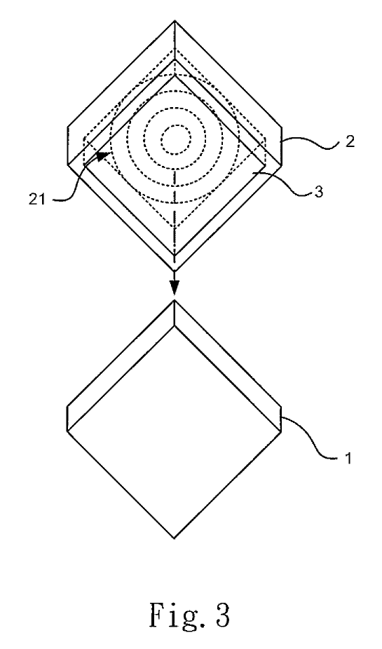

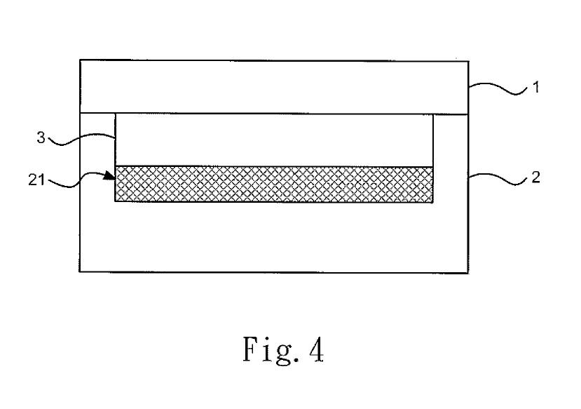

(c) In FIG. 3 and FIG. 4, the light transmission substrate 1 is laid on the molding material over the mold 2 to form the molding material layer 3 by pressing.

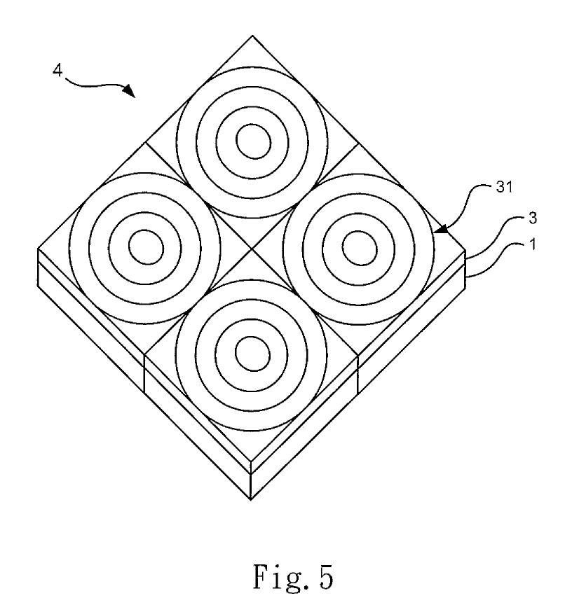

(d) In FIG. 5, after forming the molding material layer 3, the mold 2 is separated from the molding material layer 3 to form a lens structure 31 on a surface of the molding material layer 3. Thus, a condenser component 4 is obtained by the light transmission substrate 1 coordinated with the molding material layer 3.

Through the above steps, a condenser component having good hardness is manufactured conveniently, easily and effectively; and a novel method of manufacturing a condenser component of concentration photovoltaic module is thus obtained.

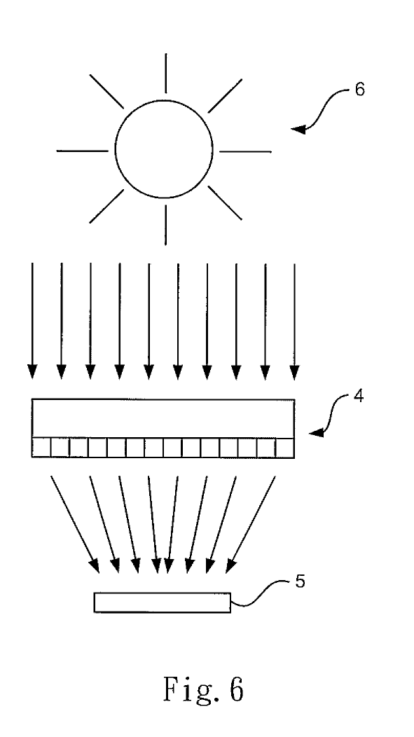

Please refer to FIG. 6, which is a view showing a state of use of a condenser component. As shown in the figure, on using a condenser component 4 manufactured according to the present disclosure, a solar cell 5 is positioned at a distance below the condenser component 4 correspondingly. When a light source 6 (ex. sun light) is shone on the condenser component 4, the light source 6 is condensed through the condenser component 4 for converging solar power on the solar cell 5 and obtaining a good output power. In addition, because the condenser component 4 is obtained through binding the molding material layer 3 on the light transmission substrate 1, the condenser component 4 has good hardness sustainable to sudden stroke and has good weatherability on being used outdoors for long.

To sum up, the present disclosure is a method of manufacturing a condenser component of concentration photovoltaic module, where a condenser component is manufactured to obtain good hardness sustainable to sudden stroke and good weatherability on being used outdoors for long.

The preferred embodiment herein disclosed is not intended to unnecessarily limit the scope of the present disclosure. Therefore, simple modifications or variations belonging to the equivalent of the scope of the claims and the instructions disclosed herein for a patent are all within the scope of the present disclosure.

What is claimed is:

1. A method of manufacturing a condenser component of concentration photovoltaic module, the method comprising:
(a) providing a light transmission substrate, said light transmission substrate being made of a hard glass material;
(b) pasting a molding material on a mold to form a molding material layer, said molding material being processed through de-voiding in a vacuum chamber, said mold having a lens forming area;
(c) deposing said light transmission substrate on said molding material layer over said mold to form said molding material layer by pressing; and
(d) after forming said molding material layer, separating said mold from said molding material layer to obtain a lens structure on a surface of said molding material layer to obtain a condenser component of said light transmission substrate coordinated with said molding material layer.

2. The method according to claim 1, wherein said hard glass material is strengthened ultra-white glass.

3. The method according to claim 1, wherein said molding material is polymer plastic.

4. The method according to claim 1, wherein said molding material is silicone.
